(19) United States
(12) Patent Application Publication
(10) Pub. No.: US 2010/0133207 A1
(43) Pub. Date: Jun. 3, 2010

(54) Outboard Motor Transportation, Storage and Maintenance System

(76) Inventors: Jacqueline Milan Dolch, Stafford, VA (US); Richard Rocke Scriven, Stafford, VA (US)

Correspondence Address: JOHN S. PRATT, ESQ;KILPATRICK STOCKTON, LLP, 1100 PEACHTREE STREET, SUITE 2800, ATLANTA, GA, 30309, US

(21) Appl. No.: 12/473,759

(22) Filed: May 28, 2009

Related U.S. Application Data
(60) Provisional application No. 61/130,450, filed on May 30, 2008.

(51) Int. Cl. A47F 13/00; B62B 1/06; B65G 67/00

(52) U.S. Cl. 211/2; 280/47.24; 211/175; 414/809

(57) ABSTRACT

A cart for an outboard motor allows the motor to be installed on the cart, raised into a vertical position, and transported with relative ease. A storage, transportation and maintenance rack is also provided. The outboard motor cart fits into the storage, transportation and maintenance rack. When secured therein, the cart and rack, with the outboard motor installed, can be easily transported and/or stored. The cart and rack include additional features that fit within the profile of the cart and/or rack and allow for storage and transportation of fuel, oil and other components required for operation and maintenance of the motor. Methods for installing an outboard motor to an outboard motor cart and for installing the outboard motor cart and outboard motor into the storage, transportation and maintenance are also described.

This application claims priority to U.S. Provisional Patent Application Ser. No. 61/130,450, filed on May 30, 2008, the disclosure of which is incorporated herein by reference in its entirety.

### FIELD OF INVENTION

This application relates to systems for transportation, storage and maintenance of outboard motors.

### BACKGROUND OF INVENTION

Outboard motors are commonly used for powering small to medium size boats. Such motors, which often are tiller steered, can be removed from their boats, which add to the attraction of their use. As such, outboard motors are often employed with rapid deployment (such as inflatable) boats used in military and first response applications. Often, during servicing or storage of such boats, and/or their motors, it becomes necessary to remove the outboard motor from the boat to conduct waterside expedient maintenance or to move the outboard motor to a convenient storage location.

However, removing outboard motors from their boats is not an easy task. These motors are heavy, cumbersome, and awkward to handle, and as such, create a safety issue for their handling. In addition, there has been a push to have more environmentally friendly motors. For example, the United States EPA has implemented higher emission standards for outboard engines, as well as making it illegal to manufacture or import into the United States the traditional lightweight two-stroke carbureted outboard motors. Such a ban has led to a shift in manufacturing to more fragile, but significantly heavier, computer-controlled two and four-stroke and direct fuel injection outboards. These newer types of outboard motors have only increased the overall weight of the motors, by 40% in some cases, making their handling even more difficult. As such, the combination of the added weight and the increased fragility has put a greater emphasis on an improved method or device to safely handle the removal, transportation, and storage of the outboard motors for military, civilian and public servants conducting water rescue and beach launches.

Modified hand trucks and other similar items have been employed to transport outboard motors in the past. However, such transportation devices have proved to be unstable on smooth, prepared surfaces and inadequate on unprepared surfaces. These devices are also ill equipped to handle the weight and fragility of these new modern outboard motors. In the case of military use, it is often the case that such motors and boats are assembled and deployed in hostile environments that expose their operators to enemy fire. As such, inflatable military and rescue boats are now quickly inflated with air from compressed air tanks to limit their operators' exposure. Civilians also have a need to move their dinghies from their yachts/larger boats to repair facilities or to storage. However, at this time, nothing has been developed to aid in the transportation of these heavier motors, which defeats the quick rescue or covert launch benefit provided by the inflatable nature of the boats. Such situations require an outboard motor transportation device that allows for quick, safe, and efficient movement and installment of the outboard motor on all types of terrain. Additionally, it is beneficial that such a device require minimal use of personnel to operate the removal, transportation, or installation of the outboard motor.

Once removed from the boat, it is also necessary to handle, transport, protect, and store the outboard motor and its related equipment. The storage structure must be able to provide a secure support form for the outboard motor, as well as protect the motor from damage during the shipping over land, sea, or air. In addition, computers and diagnostic tools may accompany the more sophisticated and fragile motors, adding another component that must be accounted for during shipping. These parts, as well as other needed tools and support equipment, should be protected during shipping, specifically from shock and saltwater corrosion. Also, the storage/transportation structure needs to efficiently retain the motor, allowing for multiple structures to be effectively shipped.

### SUMMARY OF INVENTION

Certain embodiments of the invention include a cart for an outboard motor that allows the motor to be installed on the cart, raised into a vertical position, and transported with relative ease. The design of the cart shifts the center of gravity of the motor closer to the wheels of the cart, substantially improving the mechanical advantage for moving the motor as compared to known systems.

Certain embodiments may also include a storage, transportation and maintenance rack that holds the outboard motor cart. When secured therein, the cart and rack, with the outboard motor installed, can be easily transported and/or stored. The rack can also be used as a maintenance platform for performing maintenance on the motor.

The cart and rack include additional features that fit within the profile of the cart and/or rack and allow for storage and transportation of fuel, oil, and other components required for operation and maintenance of the motor.

In an exemplary embodiment, an outboard motor transportation and support apparatus includes two generally triangular frames connected by at least one cross support member, the frames being spaced apart and generally parallel to each other and each frame having a first end, a second end, and a third end. The apparatus also includes at least one wheel coupled to the apparatus near the first end of each frame, a false transom near the second end of each frame for connecting a motor to the apparatus, and a first side between the first and third ends of each frame. The third end of each frame has a portion extending generally perpendicular to the first side. The apparatus is configured such that the center of gravity of a motor attached to the apparatus is over (or relatively close to over) the wheels of the apparatus, which makes it easier to tilt and move a motor attached to the apparatus.

In another exemplary embodiment, an outboard motor transportation and support apparatus includes an outboard motor cart having two generally triangular frames connected by at least one cross support member, a false transom for connecting a motor to the apparatus, at least one pair of wheels for facilitating movement of the outboard motor cart, and a storage, transportation and maintenance rack for storing and facilitating maintenance of the outboard motor cart.

Methods for installing an outboard motor to an outboard motor cart and for installing the outboard motor cart and outboard motor into a storage, transportation and maintenance rack are also described.

### BRIEF DESCRIPTION OF THE DRAWINGS

FIG. 1 is a side profile view of a system according to one embodiment of the invention.

FIG. 2 is a side profile view of a storage, transportation and maintenance rack according to an embodiment of the invention.

FIG. 3 is front profile view of a storage, transportation and maintenance rack according to an embodiment of the invention.

FIG. 4 is a perspective view of an outboard motor cart according to one embodiment of the invention.

FIG. 5 is another perspective view of an outboard motor cart according to an embodiment of the invention.

FIG. 6 is a perspective view of an outboard motor cart and outboard motor according to an embodiment of the invention.

FIG. 7 is a side view of a system according to one embodiment of the invention.

FIG. 8 is another side view of a system according to an embodiment of the invention.

FIG. 9 is a side view of a system according to one embodiment of the invention.

FIG. 10 is a perspective view of an outboard motor cart and outboard motor according to an embodiment of the invention.

FIG. 11 is another perspective view of an outboard motor cart and outboard motor according to one embodiment of the invention.

FIG. 12 is a perspective view of a diagnostics pod according to an embodiment of the invention.

FIG. 13 is a perspective view of an oil storage container according to one embodiment of the invention.

FIG. 14 is a perspective view of a computer workstation and work bench according to an embodiment of the invention.

FIG. 15 is a perspective view of a lower gear case holder according to one embodiment of the invention.

FIG. 16 is a perspective view of a work bench, tool box and lower gear case holder according to an embodiment of the invention.

### DETAILED DESCRIPTION OF INVENTION

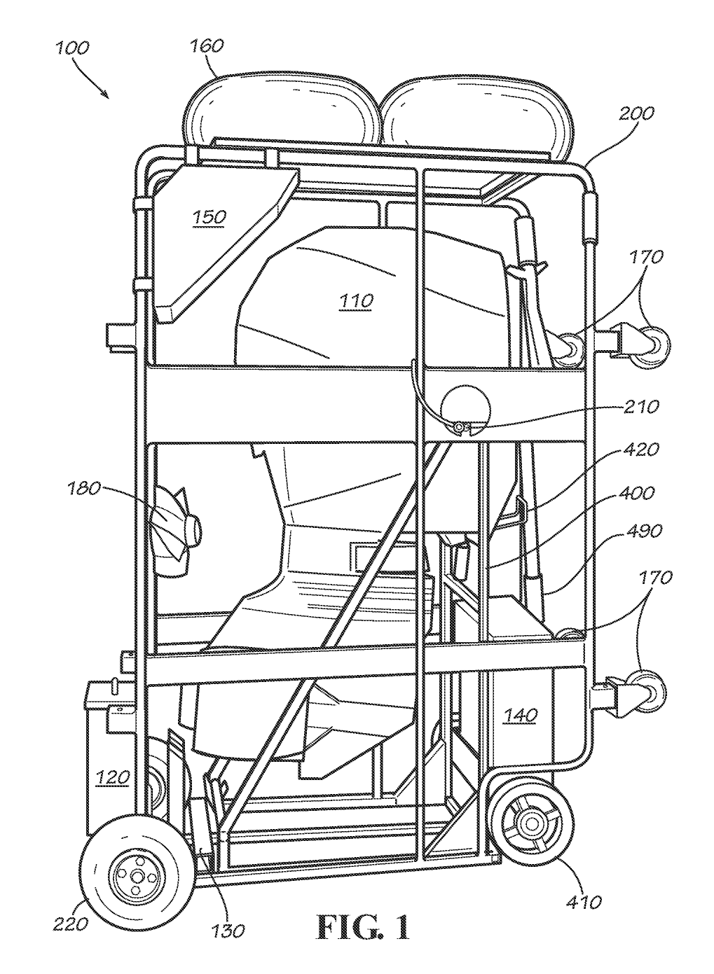

Certain embodiments of this invention provide a self-contained outboard motor transportation and storage system 100 that allows a single person to remove, attach, store, transport, and perform maintenance and repairs to an outboard motor 110, as shown in FIG. 1. The system 100 includes as primary components an outboard motor cart 400 and a storage, transportation and maintenance rack 200 (hereinafter referred to as “rack”) installed therein and held in place with, e.g., a locking pin 210 or another suitable securing mechanism. The outboard motor cart 400 is configured to be removable from the rack 200.

When connected, the outboard motor cart 400 and rack 200 can be moved together by pushing or pulling the system 100 on wheels 410 and wheels 220. Wheels 220 are optional—if they are not installed, the system can be pushed or pulled by tipping the system back onto wheels 410 and moving it like a hand truck or other similar apparatus.

The system 100 may also include one or more storage compartments, or pods, for storing fuel, oil, and other components required for operation and maintenance of an outboard motor. Exemplary storage pods illustrated in FIG. 1 and described in more detail below include an oil storage container 120, a lower gear case holder 130, a tool box 140, and a diagnostics pod 150. The storage pods are preferably removable, but they could also be permanently attached to the outboard motor cart 400 or rack 200.

Other optional components include: beach wheels 160 attached to rack 200 in a storage position which can be removed and used in place of either wheels 410 or optional wheels 220 to enable the system to be more easily moved on sandy or other soft surfaces; shop wheels 170 for moving the rack 200 when the rack is in a maintenance position (as described below); a spare impeller/propeller 180; and a hook 420 for a fuel bladder.

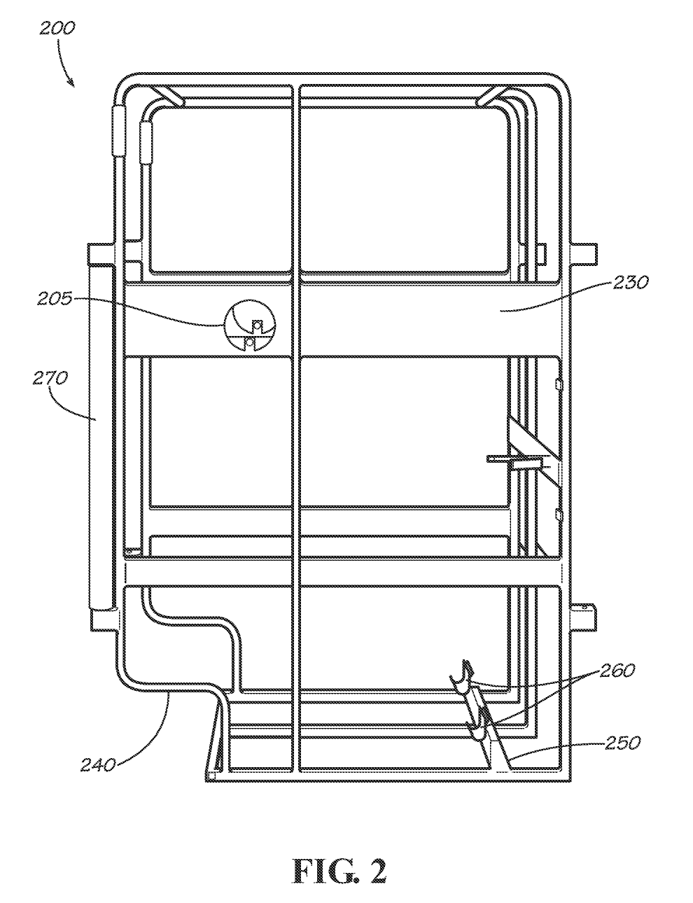

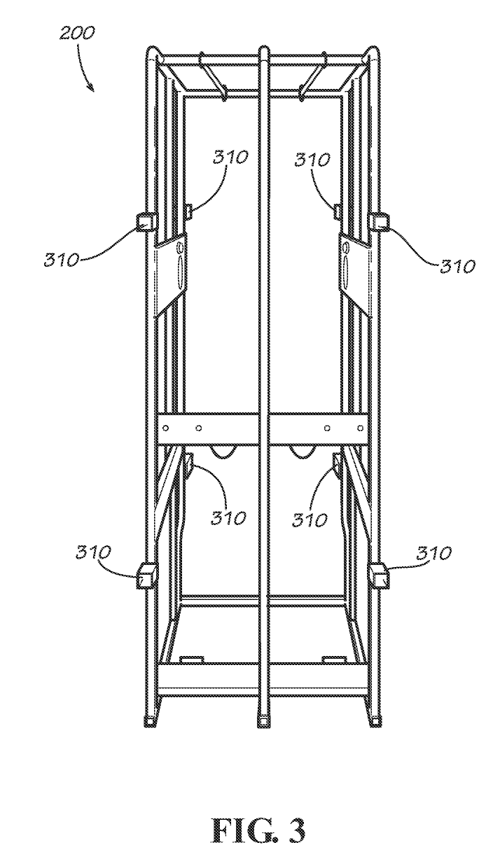

The rack 200, further illustrated in FIGS. 2 and 3, provides a reusable protective structure for the outboard motor 110 during shipping and storage. The rack is designed to retain the outboard motor cart 400. The rack is preferably made of a sturdy, but lightweight material, such as hollowed steel piping. However, other materials, including, but not limited to, aluminum or chrome alloys, may be used. Whatever material used, the rack should be able to support the weight of an outboard motor without compromising the integrity of the structure.

The rack 200 has a generally rectangular frame. One side of the rack is open along a portion to allow access for the outboard motor cart 400 to reach the unit's interior. When placing the outboard motor cart 400 in the rack, this open portion should be aligned vertically. Protective shipping plates 230, shown best in FIG. 2, can be installed along the sides of the rack 200. The shipping plates 230 provide a surface on which to place warnings and protect the outboard motor 110 during shipping. These plates may be attached directly to the frame or to corner braces that are provided for extra support of the rack 200. The shipping plates 230 have a small tolerance to minimize lateral movement of the outboard motor 110 from side-to-side.

The corners of the frame have a generally rounded shape, as best shown in FIG. 2. The rounding of the corners of the rack 200 assists in transportation and minimizes the risk that the corners will catch on surfaces, which could hinder storage and shipping of the outboard motor within the system.

The corners along one bottom end of the frame of the rack 200 are inversed 240, providing space for the wheels 410 of the outboard motor cart 400. By moving the wheels 410 of the outboard motor cart 400 further within the rack 200, the wheels are moved closer to the center of gravity for the overall device. This creates a greater mechanical advantage for an operator, making it easier to tip and move the rack 200, outboard motor cart 400 and outboard motor 110.

A catch plate 250 may be located along the bottom portion of the rack 200 opposite the inversed corners. The catch plate 250 provides a surface for the outboard motor cart 400 to engage while being retained within the rack 200. The catch plate 250 allows the outboard motor cart 400 to be properly installed into the rack 200 at night or in other low-light conditions. Also, extensions 260 may be found within the interior portion of the frame to provide support for the outboard motor when the rack is in a horizontal position. Other securing means may be provided between the outboard motor cart 400 and the rack 200 to ensure the outboard motor 110 does not significantly shift during shipping or storage. For example, apertures 205 may be provided in the rack 200 and the outboard motor cart 400 that align with one another to receive a locking pin 210 when the outboard motor cart 400 is in the proper position within the rack 200. Also illustrated in FIG. 2 and described in more detail below is a removable work bench 270 attached to the rack 200.

As illustrated in FIG. 3, storage pegs 310 may be found along the sides of the rack 200. These pegs 310 allow the racks 200 to be stacked in a horizontal position upon one another during shipping or storage. Additionally, the pegs may be used as guides for use with a forklift.

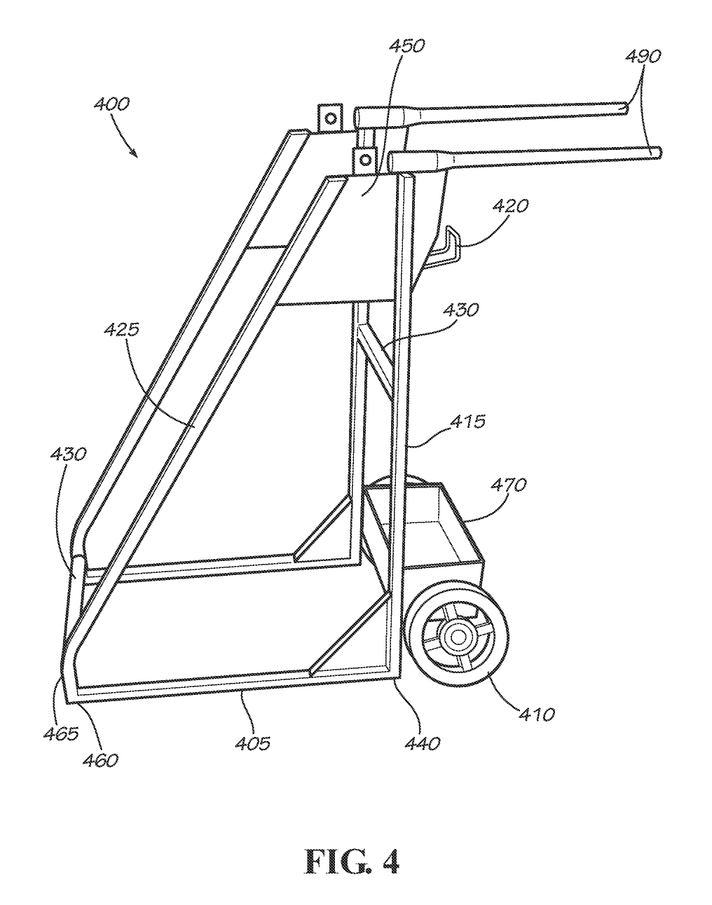

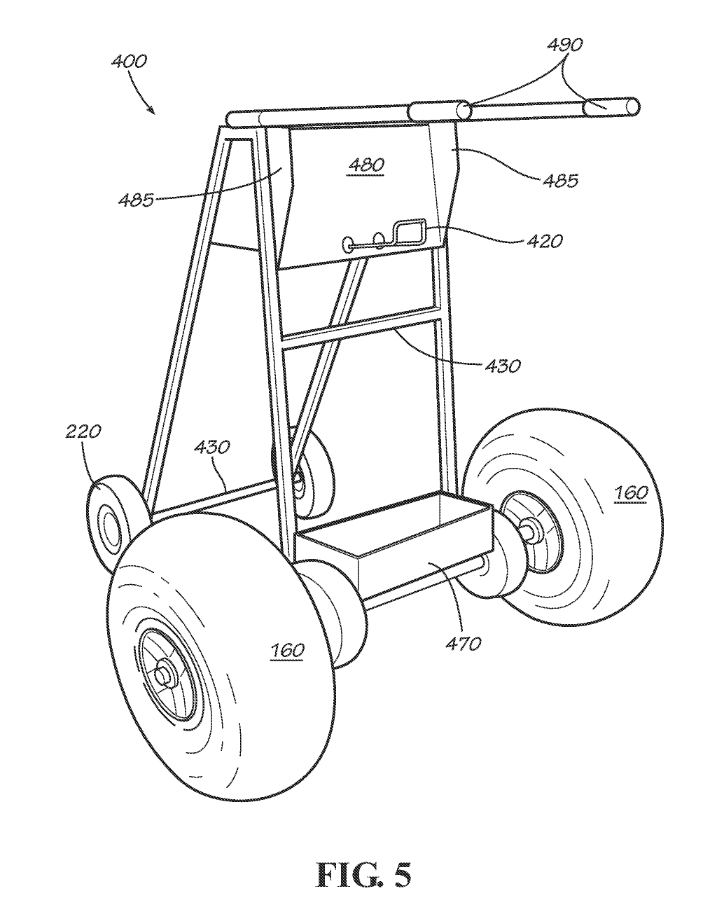

The outboard motor cart 400, as shown in FIGS. 4 and 5, is constructed to support an outboard motor. It is preferably made of the same material from which the rack 200 is made, but it can be formed from other materials as well. The cart preferably takes on a generally triangular appearance from a profile view, with the tubing forming two generally triangular frame pieces connected through cross supports 430 at various locations. The frame pieces are preferably substantially parallel to each other, as shown, but do not have to be—the frames could be generally parallel to each other, including being slightly wider at the bottom than at the top, for example, if desired.

The outboard motor cart 400 is sized to fit within the profile of the rack 200 with an outboard motor 110 attached to the outboard motor cart 400. In other words, preferably no portion of the outboard motor cart 400 or outboard motor 110 extends beyond any side of the rack 200. The rack 200 thus envelops the outboard motor cart 400 and outboard motor 110 and protects the outboard motor from damage.

The outboard motor cart 400 has three “ends” 440, 450 and 460 generally corresponding to the corners of the generally triangular frames and three “sides” 405, 415 and 425 generally corresponding to the sides of the generally triangular frames. It will be understood that, as illustrated, the frames do not necessarily have “corners” and “sides” such as what one would associate with an actual triangle (i.e., the three sides of the generally triangular frames do not necessarily meet each other at the ends of the frame). A first end 440 of the outboard motor cart has at least one axle (not illustrated) to which a set of wheels 410 (FIG. 4), 160 (FIG. 5), is attached and optionally includes a tray 470 for holding a removable storage compartment such as a tool box 140.

The design of the outboard motor cart takes advantage of the odd shape of the outboard motor by placing the axle and wheels of the outboard motor cart 400 substantially under the center of gravity of the motor 110. The location of the axle and wheels thus allow for a greater mechanical advantage for an operator when transporting the oddly shaped outboard motor 110 on the outboard motor cart 400. This provides a substantial improvement in mechanical advantage—and represents a significant improvement—over previously known outboard motor transportation systems.

As discussed, the outboard motor cart 400 may have a variety of detachable wheels that can be attached to the axle, depending on what type of terrain the motor or the rack is to be transported across. For example, wheels made for sand, rock, or smooth surfaces may be included. An additional set of temporary wheels (e.g., wheels 220) with their own axle may be provided with the outboard motor cart 400 that may be attached to various locations on the outboard motor cart 400, or rack 200, to assist in transportation of the outboard motor.

At second end 450, a false transom 480 connects two generally triangular frames, providing a support for the outboard motor 110, as discussed below.

The false transom 480 is a support structure such as a 2×10 piece of wood or other similar component that provides a support for the outboard motor 110. Fins 485 may also be connected at the second end of the outboard motor cart 400 proximate to the false transom 480 for preventing lateral movement of an attached outboard motor. The false transom 480 provides a rigid surface for attachment of the outboard motor 110 to the outboard motor cart 400 via a tilt bracket on the outboard motor, as described below.

A hook 420 for a fuel bladder or other piece of equipment may be provided near the bottom of the false transom 480. The hook 420 may be used to retain a fuel bladder (not illustrated) that is commonly found in outboard motors used in military applications. In addition to providing support for a tool box 140, tray 470 could also provide support for the fuel bladder or another storage compartment.

Handles 490 connected at the second end 450 may also be provided to facilitate operation of the outboard motor cart 400. The handles may be fixed, but are preferably rotatable. Thus, the handles 490 may be extended beyond the frame when transporting the outboard motor cart 400. When not needed, the handles 490 may be rotated up or down into a storage position.

The third end 460 of each generally triangular frame includes an additional cross support 430. As illustrated in FIG. 4, a portion 465 of the side 425 of the frame between the second end 450 and third end 460 is generally perpendicular to the side 405 between the first end 440 and third end 460. This generally perpendicular portion 465 assists the user during installation and removal of an outboard motor 110 from the outboard motor cart 400, as described below.

Additional supports may also be provided at the second end 450 of the generally triangular frame to provide further support for the outboard motor cart 400.

Having now described the rack 200 and outboard motor cart 400, the operation of these components will be described.

It will be understood that an outboard motor 110 has a tilt bracket (not illustrated) that attaches to the back of a boat. This tilt bracket allows rotation of the outboard motor 110 from an operating position (i.e., the motor is attached to the boat and in a vertical position with the impeller/propeller in the water) to a raised position with the motor substantially out of the water.

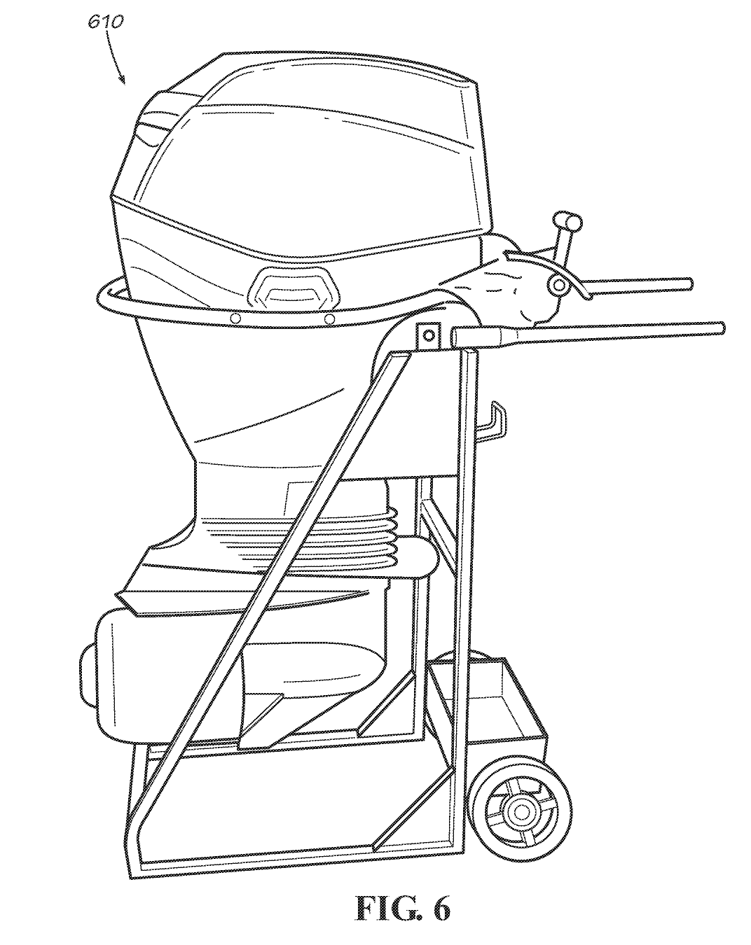

To install an outboard motor 110 onto the outboard motor cart 400, an outboard motor is staged on the ground on its back (see the back of the outboard motor, reference no. 610 in FIG. 6). The tilt bracket on the outboard motor is positioned into the raised position, and then the motor is rotated on the impeller housing and stood on its end. At this point the outboard motor 110 is ready to receive the outboard motor cart 400.

The outboard motor cart 400 is rotated about the third end 460 onto generally perpendicular portion 465 (i.e., counterclockwise as the cart is viewed in FIG. 4) until the false transom 480 lines up with the tilt bracket on the outboard motor 110. In this position, the outboard motor cart 400 substantially balances on generally perpendicular portion 465. The false transom 480 is then inserted into the tilt bracket of the outboard motor 110 and clamps on the tilt bracket are attached to the false transom 480. The outboard motor 110 and outboard motor cart 400 are now connected to each other.

The outboard motor cart 400 with the installed outboard motor is now rotated clockwise (with reference to FIG. 4) back to standing position, with sides 405 generally parallel to the ground. Generally perpendicular portion 465 acts as a fulcrum, substantially reducing the force required to lift the outboard motor cart 400 into the standing position. The tilt bracket on the outboard motor can then be rotated into the operating position so that the motor is vertical, as shown in FIG. 6. In this position, the center of gravity of the outboard motor 110 is very well balanced over (or substantially over) the wheels of the cart such that the outboard motor cart 400 and outboard motor 110 can easily be moved by only one person by tilting the cart back onto wheels 410 and moving the cart and motor like a hand truck.

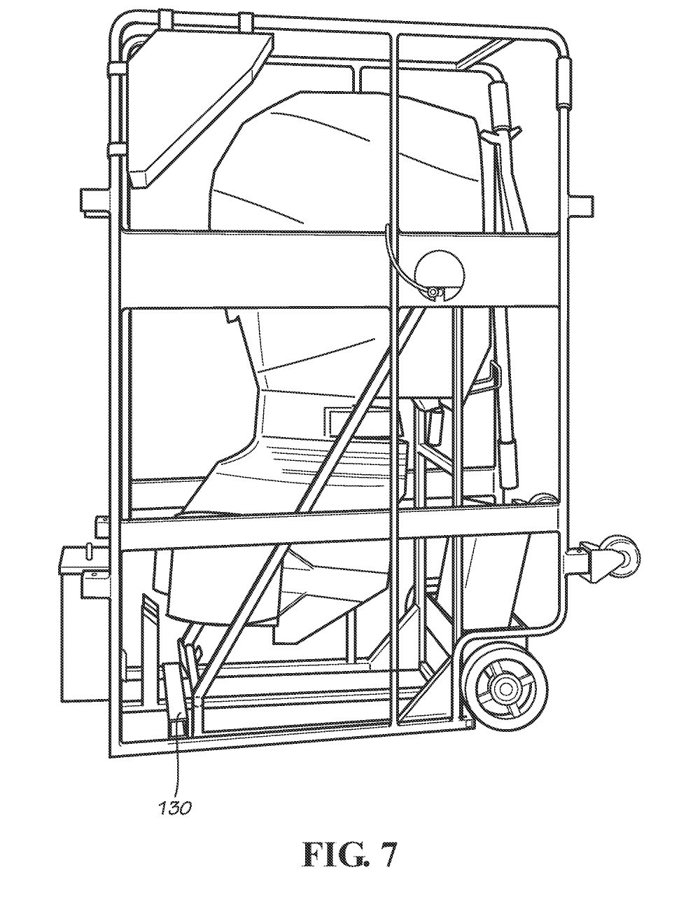

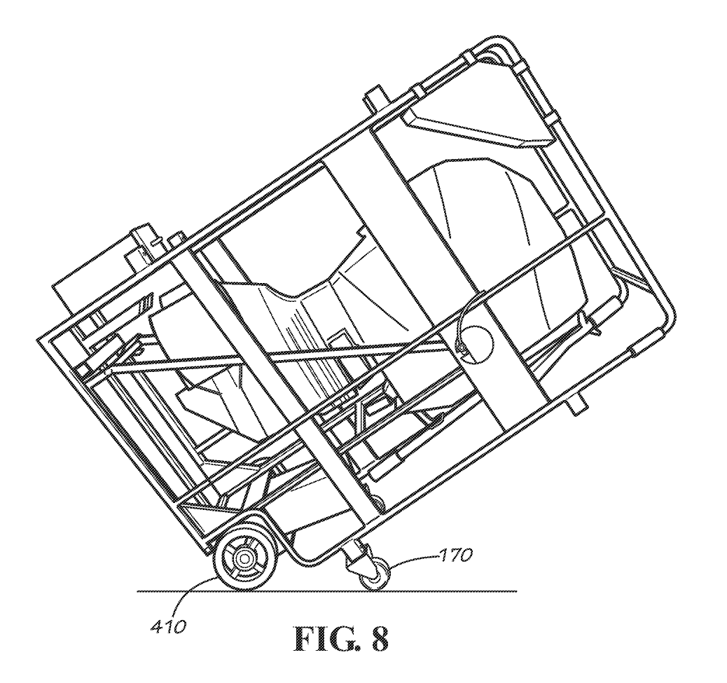

If desired, the outboard motor cart 400 can be installed into the rack 200 by moving the outboard motor cart into the rack through its open side and engaging the cross brace 430 at the third end 460 of the outboard motor cart 400 onto extensions 260 on catch plate 250. The outboard motor cart 400 and rack 200 can then be fastened together with locking pin 210 or other suitable securing mechanism. FIG. 7 illustrates the outboard motor cart 400 with outboard motor 110 installed into the rack 200. As illustrated in FIG. 8, the combined apparatus can be moved by tilting the rack onto wheels 410 and, optionally, shop wheels 170. As explained above, the rack 200 is configured to allow the wheels 410 of outboard motor cart 400 to be inserted under the rack 200 (into inversed portion 240), moving the center of gravity of the combined apparatus over (or substantially over) the wheels 410 of the outboard motor cart 410. This increases the mechanical advantage gained by an operator in tilting and moving the apparatus, allowing it to be moved by only one person.

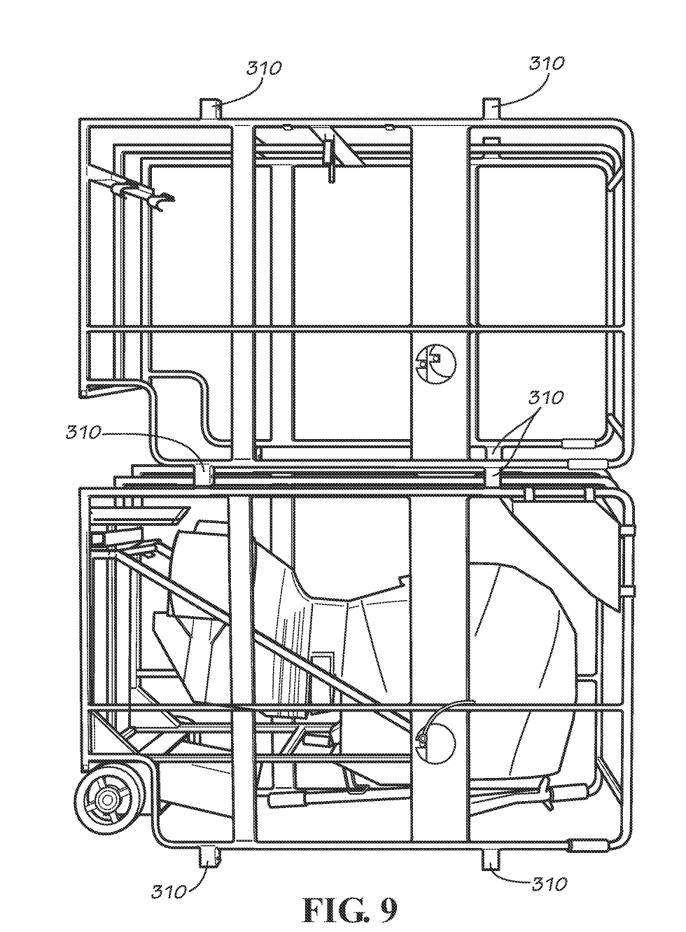

As shown in FIG. 9, the rack 200, with or without the outboard motor cart 400 and/or outboard motor 110 installed therein, can be stacked onto another rack to maximize use of space. Storage pegs 310 may be included on the rack 200 to assist in guiding the stacked racks onto each other. This feature is particular useful in cramped quarters of a naval ship.

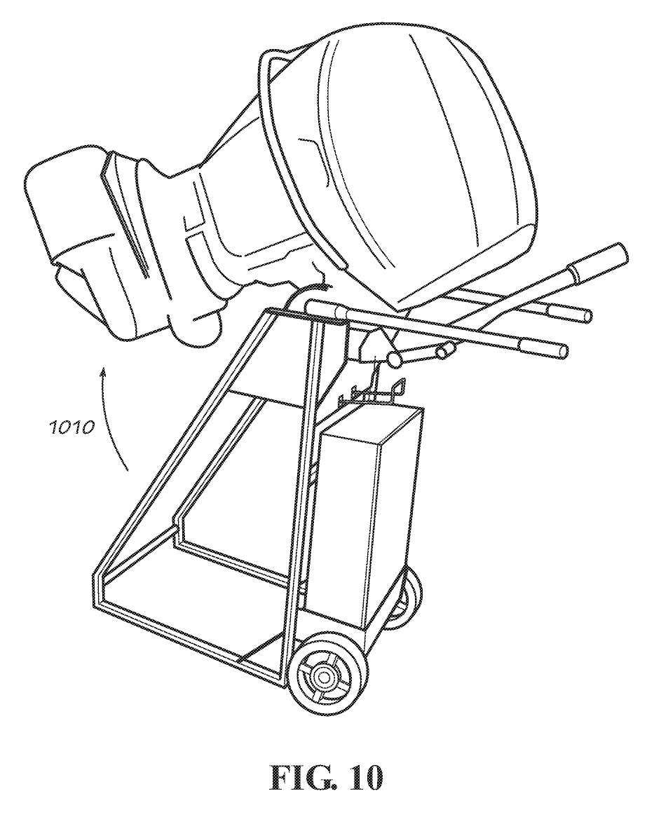

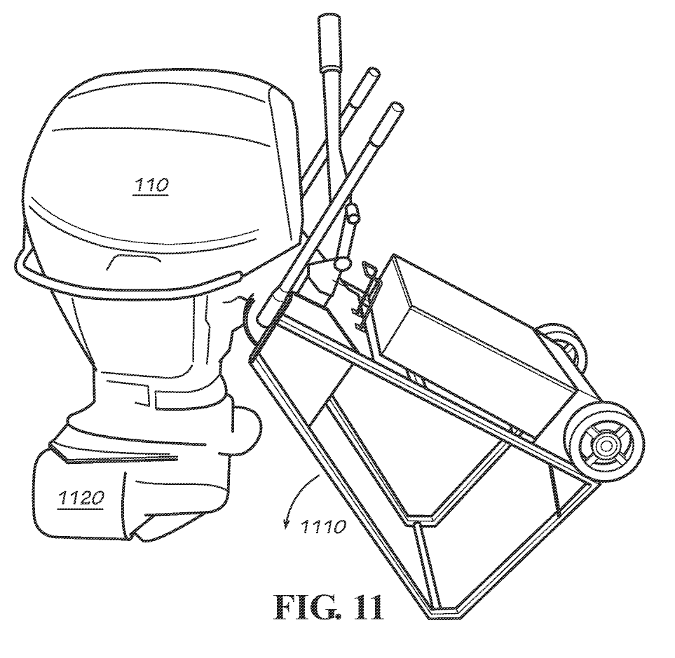

To detach the outboard motor 110 from the outboard motor cart, the process described above for installing the motor on the cart is reversed: the outboard motor cart 400 is unlocked and removed from the rack 200; the tilt bracket on the motor is rotated 1010 (FIG. 10) so that the motor is in the raised position; the outboard motor cart 400 is rotated counterclockwise 1110 (FIG. 11) until the motor rests on the ground on the impeller housing 1120; the clamps on the tilt bracket of the outboard motor are removed from the false transom 480; and the outboard motor cart 400 is removed from the outboard motor 110. At this point, the outboard motor 110 is standing on the impeller housing 1120 with the tilt bracket in the raised position and the outboard motor 110 can be lowered to connect the outboard motor to the boat.

As mentioned above, the outboard motor cart 400 and rack 200 are configured such that all operations can be accomplished with one or two operators, thus substantially decreasing the labor required to manipulate and transport the motor. This is accomplished by the design of the outboard motor cart 400 and rack 200 that allow the wheels 410 of the outboard motor cart to get closer to the center of gravity of the oddly shaped outboard motor 110 than prior outboard motor transportation systems. This allows for a substantial improvement in mechanical advantage—and represents a significant improvement—over previously known outboard motor transportation systems.

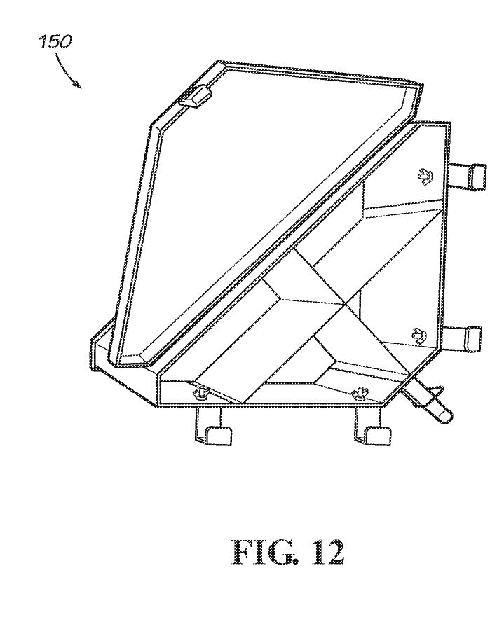

As mentioned above, another feature provided by the system 100 is that it provides for storage and transportation of fuel, oil, and other components required for operation and maintenance of an outboard motor. Some of these features are described above and others are described below with reference to FIGS. 12-16.

As discussed above, more modern outboard motors may utilize an internal computer. Such engines require diagnostic tools and the use of personal computers to make sure the engine is running correctly. With this in mind, this system may also include detachable storage pods that interact with the outboard motor cart 400 and/or rack 200. The pods may retain oil, diagnostic tools, engine tools, or other various components needed in the maintenance of the outboard motor. As such, the pods may come in various shapes and sizes. The storage pods are preferably retained within the rack 200 without occupying space needed for the outboard motor 110 or the outboard motor cart 400. This reduces the amount of space occupied by the entire system 100, which can reduce transportation and storage costs. This configuration also helps to protect the storage pods and other components from damage. The pods may be attached through a clamping system, as illustrated in, e.g., FIGS. 12 (showing a diagnostics pod 150) and 13 (showing an oil storage container 120), which allows the pods to be easily removed and attached. However, other means for attachment, such as, but not limited to, fasteners, washers, and pins, may be used.

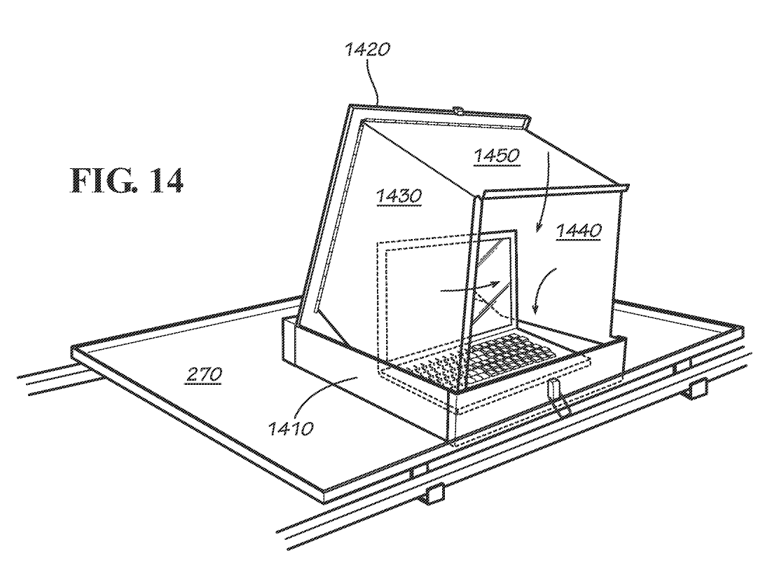

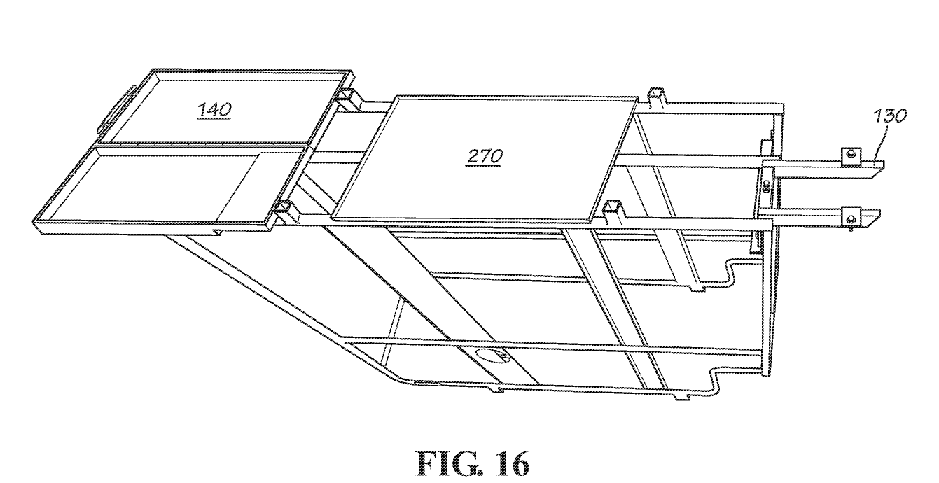

The detachability of the pods from the rack 200 provides another benefit for the system: a modifiable workstation as shown in FIGS. 14 and 16. The rack 200 may be positioned in a horizontal position with the work bench 270 on the top of the rack. Optional shop wheels 170 on the bottom of the rack 200 allow the rack to be easily repositioned as desired.

One pod can be used for the storage of diagnostic equipment, as shown in FIG. 12. This particular embodiment of the diagnostic pod is a five-sided closed container. One of the sides may be hingedly attached as a lid. The diagnostic pod is preferably configured to hold the required cables and interfacing wires for the outboard motor using a minimum of space.

Another pod, designed for specific use with a display device, such as a screen of a laptop computer, as shown in FIG. 14. The pod contains a static portion, made of a rectangular bottom and four vertically extended portions connected to the rectangular bottom, forming an open box 1410. A generally rectangular lid 1420 is hingedly attached to the back vertical portion of the open box. Hingedly attached to the interior portion of the remaining edges of the lid are three plates, two side plates 1430, 1440 and a top plate 1450. The side plates 1430, 1440 are attached on opposite edges of the lid 1420. The top plate 1450 is attached on along the edge of the lid opposite the open box. The side plates 1430, 1440 are shorter in length than the length of the lid, which allows the side plates to fold on top of one another and underneath the top plate. These plates interact with the lid to form a shield for blocking sunlight or other bright lights. A user would lift the lid 1420 and place the computer in the open box, then lift the top plate 1450 and extend the side plates 1430, 1440 until they are resting on the vertical portions of the open box. The top plate can then be rested upon the side plates, forming an enclosure for the computer. The plates provide a shaded area for which to view the screen of the laptop computer or display. When a computer is being stored, all the plates are folded towards the interior of the lid, with the top lid resting on top of the side plates.

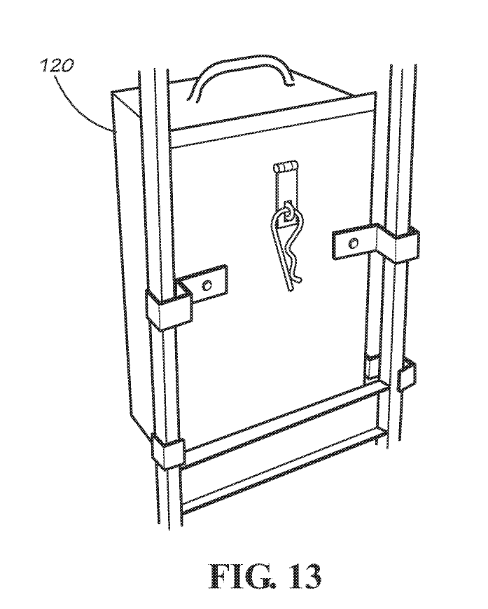

FIGS. 1 and 13 display another pod, an oil storage container 120, specifically designed to hold the oil for the outboard motor. Next to fuel, oil is the most essential element needed for operation of the outboard motor. The oil pod is designed to be easily attached and removed, just as with the other pods. Additionally, the oil pod is designed to contain leaks or spills from the oil container. In some embodiments, the oil pod may include an absorbent material found at the bottom of the pod to absorb lost oil. The oil pod has a hinged lid which may have a locking clasp. A handle may be provided for the pod's easy removal.

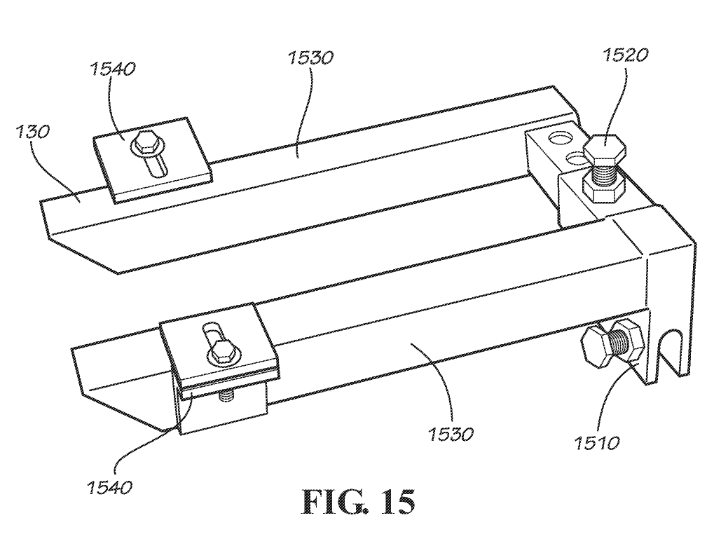

FIG. 15 provides another view of the lower gear case holder 130. This holder can also be seen in the bottom left of the illustration of FIG. 1 in a storage position. The lower gear case holder is configured to hold the “lower gear” of outboard motor 110 when it is removed for maintenance or repair. The lower gear case holder attaches to the side of the rack 200 via a pair of bolts 1510 (only one of which is visible in FIG. 15) when the rack is in its maintenance position (see FIG. 16). These bolts 1510 also secure the lower gear case holder to the storage and maintenance rack in its storage position (FIG. 1). The lower gear case holder is adjustable and can be widened by loosening adjustment bolt 1520, spreading bars 1530 apart, and then re-tightening adjustment bolt 1520. Brackets 1540 hold the fins of the lower gear in place during maintenance and repair operations. A non-adjustable lower gear case holder is described in U.S. Pat. No. 4,254,946, the disclosure of which is incorporated herein in its entirety.

FIG. 16 illustrates another embodiment of the rack 200 in its maintenance position. The work bench 270 and lower gear case holder 130 are installed on the rack, as is tool box 140. As illustrated in FIG. 16, tool box 140 is configured to open from the middle (like a clamshell) and fit onto the rack to provide an additional horizontal working surface. The tool box 140 is also sized to fit particular tools for use in outboard motor maintenance and repair, such as a shift rod indicator or universal gear puller, each of which are specialized tools for outboard motor repair and maintenance and which are easily damaged if not stored in a protective case.

The pods and other removable components discussed above can be installed in any location on the rack 200 where there is room on the rack. The pods and components should be arranged on the rack, however, so as to maintain the center of gravity over (or substantially over) the wheels of the outboard motor cart 400 when the outboard motor cart, with attached outboard motor 110, is connected to the rack 200. This will ensure that the mechanical advantage gained by having the center of gravity of the apparatus over the wheels 410 of the outboard motor cart 400 is maintained.

Additional pods or removable components not described above or illustrated in the drawings could also be added to the cart. For example, if the rack 200 and outboard motor cart 400 are used with a smaller outboard motor 110 and/or there is sufficient room in the rack 200, an inflatable boat could be attached to the rack 200, provided that the mechanical advantage gained by having the center of gravity of the apparatus over the wheels 410 of the outboard motor cart 400 is maintained.

The foregoing description of the exemplary embodiments of the invention has been presented only for the purposes of illustration and description and is not intended to be exhaustive or to limit the invention to the precise forms disclosed. Many modifications and variations are possible in light of the above teaching. The embodiments were chosen and described in order to explain the principles of the invention and their practical application so as to enable others skilled in the art to utilize the invention and various embodiments and with various modifications as are suited to the particular use contemplated. Alternative embodiments will become apparent to those skilled in the art to which the present invention pertains without departing from its spirit and scope.

What is claimed is:

1. An outboard motor transportation and support apparatus comprising:
two generally triangular frames connected by at least one cross support member, the frames being spaced apart and generally parallel to each other and each frame having a first end, a second end, and a third end;
at least one wheel coupled to the apparatus near the first end of each frame;
a false transom near the second end of each frame for connecting a motor to the apparatus;
a first side between the first and third ends of each frame; and
the third end of each frame having a portion extending generally perpendicular to the first side.

2. The apparatus of claim 1, further comprising a second wheel coupled to the apparatus near the third end of each frame.

3. The apparatus of claim 1, further comprising a rotatable handle attached near the second end of each frame.

4. The apparatus of claim 1, further comprising a tray for supporting at least one storage compartment or a fuel bladder.

5. The apparatus of claim 1, further comprising a hook for supporting a fuel bladder.

6. The apparatus of claim 1, wherein the center of gravity of a motor connected to the apparatus is substantially over the wheel coupled to each of the generally triangular frames.

7. An outboard motor transportation and support apparatus comprising:
an outboard motor cart comprising two generally triangular frames connected by at least one cross support member, a false transom for connecting a motor to the apparatus and at least one pair of wheels for facilitating movement of the outboard motor cart; and
a rack for storing the outboard motor cart.

8. The apparatus of claim 7, wherein the outboard motor cart is sized to fit within the rack.

9. The apparatus of claim 8, wherein the outboard motor cart does not extend beyond any side of the rack.

10. The apparatus of claim 7, wherein the rack further comprises a catch plate configured to receive one of the at least one cross support members of the outboard motor cart for securing the outboard motor cart within the rack.

11. The apparatus of claim 8, wherein the rack includes a frame and wherein a portion of the frame is inversed to receive the at least one pair of wheels of the outboard motor cart.

12. The apparatus of claim 7, further comprising at least one detachable storage compartment.

13. An outboard motor transportation and storage system, comprising:
a detachable outboard motor cart;
a rack; and
at least one detachable storage compartment.

14. The system of claim 13, wherein the at least one storage compartment comprises an oil storage container, a diagnostics pod, a computer pod, a tool box, or a combination thereof.

15. The system of claim 14, further comprising one or more of the following components removably attached to the rack: a work bench, a lower gear case holder, spare wheels, shop wheels, a spare impeller, a fuel bladder, or a combination thereof.

16. The system of claim 13, further comprising a horizontal work surface on the rack for repairing or maintaining an outboard motor.

17. The system of claim 13, further comprising a mechanism for securing the outboard motor cart to the rack.

18. The system of claim 13, wherein the rack further comprises storage pegs to facilitate stacking of the rack.

19. A method for installing an outboard motor to an outboard motor cart,
wherein the outboard motor cart comprises:
two generally triangular frames connected by at least one cross support member, the frames being spaced apart and generally parallel to each other and each frame having a first end, a second end, and a third end;
at least one wheel coupled to the cart near the first end of each frame;
a false transom near the second end of each frame for connecting a motor to the cart;
a first side between the first and third ends of each frame;
the third end of each frame having a portion extending generally perpendicular to the first side;
wherein the outboard motor comprises a tilt bracket for adjusting the outboard motor between an operating position and a raised position,
the method comprising:
lifting the outboard motor into a vertical position;
adjusting the tilt bracket on the outboard motor into the raised position;
rotating the outboard motor cart about the third end of each frame until the outboard motor cart rests on the portion of the third end of each frame extending generally perpendicular to the first side of each frame;
attaching the false transom to the tilt bracket; and
rotating the outboard motor cart and outboard motor about the third end of each frame until the first side of each frame is generally parallel to the ground.

20. The method of claim 19, further comprising installing the outboard motor cart and outboard motor into a rack, wherein the rack includes a catch plate for receiving the outboard motor cart, comprising
inserting the outboard motor cart and outboard motor into a side of the rack until the outboard motor cart engages the catch plate.
